(19) United States
(12) Patent Application Publication
(10) Pub. No.: US 2012/0063561 A1
(43) Pub. Date: Mar. 15, 2012

(54) FUEL ASSEMBLY

(75) Inventors: Takeshi MITSUYASU, Hitachi (JP); Motoo AOYAMA, Mito (JP); Tetsushi HINO, Hitachi (JP); Takuji NAGAYOSHI, Hitachi (JP); Masao CHAKI, Hitachi (JP)

(73) Assignee: Hitachi-GE Nuclear Energy, Ltd.

(21) Appl. No.: 13/222,366

(22) Filed: Aug. 31, 2011

(30) Foreign Application Priority Data
Sep. 15, 2010 (JP) 2010-206332

(51) Int. Cl. G21C 3/32

(52) U.S. Cl. 376/435

(57) ABSTRACT

A fuel assembly has a constitution in which plural fuel rods are arranged in 10 rows by 10 columns in a channel box, and includes plural fuel rods G containing gadolinium and plural partial length fuel rods P. In the fuel assembly, average enrichment of lower portion cross section is approximately 4.6 wt %, and average enrichment of upper portion cross section is approximately 4.7 wt %. The average enrichments at the outermost layer are approximately 5.6 wt % both in the upper portion and the lower portion. Ratios e/x of the average enrichment of the outermost layer e (wt %) to the average enrichment of the fuel assembly cross section x (wt %) are 1.19 in the upper portion and 1.22 in the lower portion, and the ratios satisfy equation (1).

$$\begin{matrix}[ Equation 1 ] & \\ \frac{e}{x} \geq - 18.3 {( \frac{x}{10} )}^{5} + 68.766 {( \frac{x}{10} )}^{4} - 101.77 {( \frac{x}{10} )}^{3} + 74.428 {( \frac{x}{10} )}^{2} - 27.372 ( \frac{x}{10} ) + 5.1682 & ( 1 )\end{matrix}$$

### CLAIM OF PRIORITY

The present application claims priority from Japanese patent application serial no. 2010-206332, filed on Sep. 15, 2010, the content of which is hereby incorporated by reference into this application.

### BACKGROUND OF THE INVENTION

1. Field of the Invention

The present invention relates to a fuel assembly and particularly to a fuel assembly suitable for use in a boiling water reactor (BWR).

2. Description of Related Art

A plurality of fuel assemblies is loaded in a core of the BWR. Each fuel assembly has a plurality of fuel rods, each of the fuel rod being loaded with a plurality of fuel pellets each containing a nuclear fuel such as uranium oxide, an upper tie plate that supports top ends of the fuel rods, a lower tie plate that supports bottom ends of the fuel rods, a plurality of fuel spacers that retains distances between respective fuel rods, and a channel box in the shape of a quadratic tube. The top end of the channel box is joined to the upper tie plate, and the channel box is directed from the upper tie plate toward the lower tie plate, and the channel box surrounds the plurality of fuel rods that are bound with the fuel spacers.

A plurality of control rods is inserted into a core so as to control power of the reactor. Some fuel rods in the fuel assembly contain burnable poison such as gadolinium in their pellets. The control rods and burnable poison absorb neutrons generated redundantly by nuclear fission of nuclear fuel material. The burnable poison gradually changes to a substance that hardly absorbs neutrons through absorption of neutrons. For this reason, the burnable poison contained in a new fuel assembly or fuel assemblies (fuel assembly or fuel assemblies having 0 GWd/t of burnup) loaded in the core, perishes when a certain operation period of the nuclear reactor has passed since the new fuel assembly (assemblies) was loaded in the core. The fuel assembly in which the burnable poison has perished, decreases their reactivity monotonously as the nuclear fuel material burns. Since the plurality of fuel assemblies having different run cycles in the core are loaded in the core, a critical state is maintained through the operation period of the nuclear reactor as a whole.

Regarding the distribution of enrichment in the fuel assembly, from a viewpoint of planarizing power peaking as shown in Japanese Patent Laid-open No. Hei 5 (1993)-142370, enrichment of each fuel rod arranged at an outermost layer of fuel rod arrangement in the fuel assembly cross section, especially the enrichment of each fuel rod arranged at the corner of the outermost layer, is lowered, and enrichment of each rod arranged on the inside of the outermost layer is heightened compared to that of the outermost layer. The fuel rods containing gadolinium are arranged at positions excluding the outermost layer.

From a viewpoint of improvement in economical efficiency of nuclear fuel, proposed is a peripheral peak type fuel assembly. In the peripheral peak type fuel assembly, average enrichment of the outermost layer of fuel rod arrangement in the fuel assembly cross section is higher than average enrichment of regions on the inside of the outermost layer. By heightening the average enrichment of the outermost layer adjacent to a water gap formed between the fuel assemblies in the core, the infinite multiplication factor of the fuel assembly can be enlarged and the burnup thereof can be increased, thereby the economical efficiency of fuel nuclear can be improved (see Japanese Patent Laid-open No. Hei 5 (1993)-27068). The peripheral peak of power distribution in the fuel assembly cross section corresponds to increasing content of uranium 235 in each fuel rod arranged at the outermost layer having large thermal neutron flux, and thereby improves neutron usage efficiency. Moreover, by changing the fuel rod arrangement from 8 rows by 8 columns to 9 rows by 9 columns, average linear heat rating decreases, thereby the peripheral peak can be utilized.

In the fuel assembly described in Japanese Patent Laid-open No. Hei 10 (1998)-170674, the peripheral peak is utilized by forming regions not containing the burnable poison at the top end and bottom end where power peaking in the axial direction becomes small, and by making the average enrichment of the outermost layer larger than the average enrichment of the fuel rods arranged at regions other than the outermost layer, in the top end region not containing burnable poison.

In the fuel assembly described in Japanese Patent Laid-open No. Sho 58 (1983)-26292, the economical efficiency of nuclear fuel is improved by heightening the average enrichment of total fuel rods at the outermost layer in comparison with the average enrichment in the fuel assembly cross section. To deal with the peaking increase at the outermost layer in the cross section, the peaking in the axial direction is lowered to planarize the peaking of the fuel assembly as a whole by increasing enrichment at the upper part of the fuel assembly at which the power comes down because of an increase in void fraction.

### PRIOR ART DOCUMENTS

(Patent Literature)
Patent Literature 1: Japanese Patent Laid-open No. Hei 5 (1993)-142370
Patent Literature 2: Japanese Patent Laid-open No. Hei 5 (1993)-27068
Patent Literature 3: Japanese Patent Laid-open No. Hei 10 (1998)-170674
Patent Literature 4: Japanese Patent Laid-open No. Sho 58 (1983)-26292

### SUMMARY OF THE INVENTION

For improving the economical efficiency of nuclear fuel, it is necessary to improve the reactivity of the fuel assembly without increasing the average enrichment in the cross section of the fuel assembly. As a method of improving the reactivity of the fuel assembly without increasing the average enrichment of cross section of the fuel assembly, a peripheral peak type enrichment distribution is conceivable for adoption. In the peripheral peak type fuel assembly, the power peaking becomes maximum in a first cycle where a new fuel assembly of burnup 0 GWd/t is loaded in the core, and after gadolinium has perished, the power peaking decreases as the nuclear fuel material burns. Generally, since the reactivity of the fuel assembly is restricted by gadolinium before gadolinium has perished (the first cycle operation for the fuel assembly), the power peaking (peripheral peaking) of the outermost layer in the fuel rod arrangement in the cross section of the fuel assembly becomes large. For the reason, before gadolinium has perished, it is not desirable to increase the reactivity of the fuel assembly. After gadolinium in the fuel assembly has perished, especially at a core operation end stage, the reactivity is needed to increase. In the fuel assembly, the core operation end stage means an end stage in the first cycle of an in-core fuel dwell. The inventors performed various studies to achieve such a situation. As a result, the inventors newly found that the reactivity increase after gadolinium has perished can be enlarged in comparison with the reactivity increase during the period before the burnable poison has perished, by arranging fuel rods with more than certain enrichment at the outermost layer in the fuel rod arrangement.

Japanese Patent Laid-open No. Hei 5 (1993)-142370, Japanese Patent Laid-open No. Hei 5 (1993)-27068, and Japanese Patent Laid-open No. Hei 10 (1998)-170674 do not disclose that the reactivity after the burnable poison has perished can be increased by restraining the reactivity at the beginning of life (BOL) of the fuel assembly.

In the fuel assembly described in Japanese Patent Laid-open No. Sho 58 (1983)-26292, the reactivity after the burnable poison has perished is increased by increasing the power peaking of the fuel rods at the outermost layer. The increase of the reactivity after the burnable poison has perished is achieved by changing enrichment distribution in the axial direction of the fuel assembly so as to reduce the power peak in the lower region of the fuel assembly.

An object of the present invention is to provide a fuel assembly capable of reducing the content of burnable poison and improving the economical efficiency of nuclear fuel.

### Means for Solving the Problems

In order to achieve the above-mentioned object, the present invention is characterized in that: a fuel assembly has plural first fuel rods containing fissile material and not containing burnable poison, and plural second fuel rods containing fissile material and burnable poison; and when a first average enrichment as an average enrichment of a cross section of the fuel assembly is expressed by x (wt %) and a second average enrichment as an average enrichment of an outermost layer in a fuel rod arrangement is expressed by e (wt %), the ratio of the second average enrichment e (wt %) to the first average enrichment x (wt %) e/x satisfies the following equation (1).

$$\begin{matrix}[ Equation 1 ] & \\ \frac{e}{x} \geq - 18.3 {( \frac{x}{10} )}^{5} + 68.766 {( \frac{x}{10} )}^{4} - 101.77 {( \frac{x}{10} )}^{3} + 74.428 {( \frac{x}{10} )}^{2} - 27.372 ( \frac{x}{10} ) + 5.1682 & ( 1 )\end{matrix}$$

Since the ratio e/x satisfies equation (1), the content of the burnable poison contained in the fuel assembly of burnup 0 GWd/t can be reduced by a neutron shielding effect of the fissile material, and reactivity of the fuel assembly before the burnable poison has perished can be restrained, and reactivity of the fuel assembly after the burnable poison has perished can be increased. The increase of the reactivity after the burnable poison has perished improves the economical efficiency of nuclear fuel.

The ratio e/x preferably satisfies equation (2).

$$\begin{matrix}[ Equation 2 ] & \\ \frac{e}{x} \geq - 0.1031 x + 1.9096 & ( 2 )\end{matrix}$$

### Advantages of the Invention

According to the present invention, it is possible to reduce the amount of the burnable poison contained in the fuel assembly with burnup of 0 GWd/t and improve the economical efficiency of nuclear fuel.

### BRIEF DESCRIPTION OF THE DRAWINGS

FIG. 1 is a cross sectional view of a fuel assembly of Embodiment 1 that is a preferable embodiment of the present invention and is applied to a BWR.

FIG. 2 is an explanation diagram showing enrichment and gadolinium concentration distribution of each fuel rod in the fuel assembly shown in FIG. 1.

FIG. 3 is a vertical sectional view of the fuel assembly shown in FIG. 1.

FIG. 4 is an explanation diagram showing an example of change of infinite multiplication factor against burnup in the fuel assembly containing gadolinium and the fuel assembly not containing gadolinium.

FIG. 5 is an explanation diagram showing an example of advantages of the fuel assembly of the present invention compared with a conventional fuel assembly by their differences of infinite multiplication factor on burnup.

FIG. 6 is a characteristic diagram showing a change of a reactivity increase in accordance with a ratio of the average enrichment of the outermost layer to the average enrichment of the fuel assembly cross section when using the average enrichment of the fuel assembly cross section as a parameter.

FIG. 7 is a characteristic diagram showing the lower limit of the ratio of the average enrichment of the outermost layer to the average enrichment of the fuel assembly cross section that causes the advantages of the present invention.

FIG. 8 is a characteristic diagram showing a relation of the ratio of the average enrichment of the outermost layer to the average enrichment of the fuel assembly cross section and the ratio of a burnup at a peak position of the reactivity increase effect to a discharge burnup.

FIG. 9 is a characteristic diagram showing a relation of the ratio of the average enrichment of the outermost layer to the average enrichment of the fuel assembly cross section and a lower limit of the average enrichment of the fuel assembly cross section at peak positions where reactivity increase effect becomes half of the discharge burnup or less.

FIG. 10 is an explanation diagram showing differences between effects obtained when equation (1) is satisfied and effects obtained when equation (2) is satisfied.

FIG. 11 is a cross sectional view of a fuel assembly as to Embodiment 2 of the present invention applied to a BWR.

FIG. 12 is an explanation diagram showing enrichment and gadolinium concentration distribution of each fuel rod in the fuel assembly shown in FIG. 11.

FIG. 13 is a cross sectional view of a fuel assembly as to Embodiment 3 of the present invention applied to a BWR.

FIG. 14 is an explanation diagram showing enrichment and gadolinium concentration distribution of each fuel rod in the fuel assembly shown in FIG. 13.

FIG. 15 is a cross sectional view of a fuel assembly as to Embodiment 4 of the present invention applied to a BWR.

FIG. 16 is an explanation diagram showing enrichment and a gadolinium concentration distribution of each fuel rod in the fuel assembly shown in FIG. 15.

FIG. 17 is a cross sectional view of a fuel assembly as to Embodiment 5 of the present invention applied to a BWR.

FIG. 18 is an explanation diagram showing enrichment and a gadolinium concentration distribution of each fuel rod in the fuel assembly shown in FIG. 17.

FIG. 19 is a cross sectional view of a fuel assembly as to Embodiment 6 of the present invention applied to a BWR.

FIG. 20 is an explanation diagram showing enrichment and gadolinium concentration distribution of each fuel rod in the fuel assembly shown in FIG. 19.

### DETAILED DESCRIPTION OF THE PREFERRED EMBODIMENTS

The inventors performed various studies on improvement measures of the economical efficiency of nuclear fuel, that is, measures for reducing the content of the burnable poison in the fuel assembly to restrain reactivity of the fuel assembly before disappearance of the burnable poison and increase a discharge burnup of the fuel assembly (improve the economical efficiency of nuclear fuel). As the result of these studies, the inventors newly found that, when the ratio of the average enrichment of the outermost layer in a fuel rod arrangement of the fuel assembly to the average enrichment of the fuel assembly cross section is set to be a certain value or more, the reactivity of the fuel assembly during a period (BOL) when the burnable poison exists in the fuel assembly can be restricted and the reactivity of the fuel assembly during a period after the burnable poison has perished can be increased. The period when the burnable poison exists in the fuel assembly is corresponding to, in other words, the period before the burnable poison has perished therein. In the fuel assembly found by the inventors, the content of the burnable poison in the fuel assembly with burnup 0 GWd/t can be reduced, the reactivity of the fuel assembly during the period before the burnable poison has perished (herein after referred to as a first period) can be restrained, and the reactivity of the fuel assembly during the period after the burnable poison has perished (hereinafter referred to as a second period) can be increased. The increase of the reactivity can increase a discharge burnup of the fuel assembly. The results of the study described above will be explained specifically.

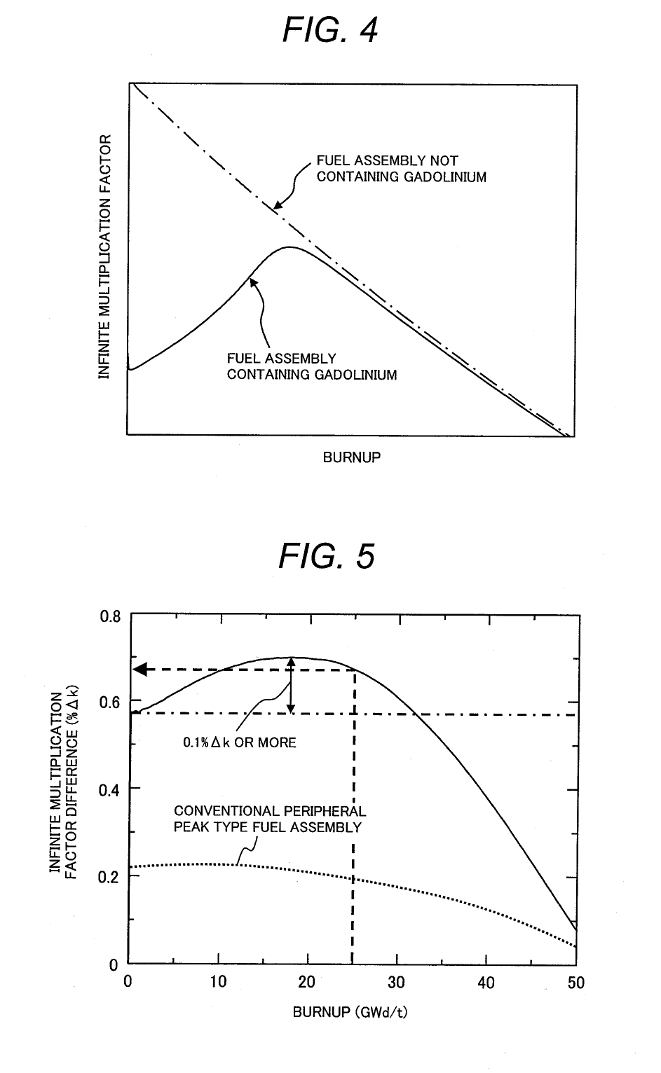

FIG. 4 shows a change of the infinite multiplication factor to the burnup in each of a fuel assembly not containing gadolinium as burnable poison in a state of burnup 0 GWd/t and a fuel assembly containing gadolinium in a state of 0 GWd/t. Generally, a fuel assembly with a burnup 0 GWd/t (new fuel assembly) contains gadolinium as burnable poison to restrain excess reactivity of the fuel assembly. Since gadolinium decreases with burnup, the reactivity of the new fuel assembly loaded in a core increases with the burnup of gadolinium. Since a part of the fuel assemblies having reached the end of their usefulness is exchanged with a new fuel assembly (fuel assemblies) every completion of the operation cycle of the reactor, plural fuel assemblies have different in-core fuel dwelling time respectively in an operation cycle at any given time (numbers of operation cycles of the plural fuel assemblies dwelling in the core of the reactor are different from each other). For the reason, a change of the excess reactivity in the core during the operation cycle becomes small, and thereby a reactivity control of the reactor can be carried out easily. However, since gadolinium in the new fuel assembly remains slightly at the point of time when a first operation cycle for the new fuel assembly is finished, as the content of gadolinium remaining in the new fuel assembly increases, the reactivity of the fuel assembly declines during a second operation cycle for the fuel assembly. Therefore, the content of gadolinium in the new fuel assembly shall be as small as possible.

For improving the usage efficiency of nuclear fuel material (such as uranium) by increasing the burnup, it is suitable to restrain the reactivity of the fuel assembly in the first period and improve the reactivity of the fuel assembly in the second period. With regard to restraining the reactivity of the fuel assembly in the first period and improving the reactivity of the fuel assembly in the second period, it means that a peak of burnup change is formed not in the first period but at the point of time when a burnup increase has developed to some extent after the beginning of the second period, in light of the following burnup change. The burnup change is of a burnup change as to the amount of reactivity increase in a peripheral peak type fuel assembly against the conventional peripheral fuel assembly in which the average enrichment of the outermost layer is lower than the average enrichment of the fuel assembly cross section, (in other words, in light of change in gain (reactivity increase) of the peripheral peak type fuel assembly against the conventional fuel assembly along with the burnup of the nuclear fuel material. The inventors found new knowledge where the peripheral peak type fuel assembly containing gadolinium at burnup 0 GWd/t forms a peak of burnup change in the second period unlike the conventional peripheral peak type fuel assembly. By formation of such a peak in the burnup change, it is possible to obtain an advantage that the reactivity increase of the peripheral peak type fuel assembly is maximized not in the first period but in the second period, and to improve the economical efficiency of nuclear fuel. In the reactivity improvement of the core, significant reactivity increase is of 0.1% Δk or more. For this reason, the peak is needed to be larger by 0.1% Δk or more than the reactivity when the peripheral peak type fuel assembly is loaded in the core with burnup 0 GWd/t. Specific examples will be described later (refer to FIG. 5).

Moreover, in general, the content of gadolinium contained in the fuel assembly at 0 GWd/t is designed so that gadolinium burns out in the first operation cycle of the fuel assembly, and gadolinium hardly exists in the fuel assembly at the end stage of the operation cycle. In other words, for the reactivity increase after gadolinium has perished, the peripheral peak type fuel assembly suitably increases the reactivity after the second operation cycle for the fuel assembly has started. Burnup in an operation cycle (referred to as cycle burnup) is determined depending on reactor power, an operation period of one operation cycle, and a fuel loading amount at burnup 0 GWd/t in the fuel assembly. When the reactor power and the fuel loading amount remain constant, the cycle burnup is increased by lengthening the operation period of the operation cycle. In that case, number of replacement times (number of batches) decrease. As described above, since there are plural fuel assemblies with different number of operation cycles in the in-core fuel dwell, the minimum number of the batches is 2. When the number of batches is 2, the ratio of number of fuel assemblies of burnup 0 GWd/t to number of fuel assemblies other than burnup 0 GW/t having experienced a reactor operation in the previous operation cycle, becomes 1 to 1, and the cycle burnup becomes half the discharge burnup. The cycle burnup is equivalent to the average burnup of the midterm of an operation cycle. So, at the time point of burnup of at least half the discharge burnup, it is desirable that the reactivity of the fuel assembly increases over that of the first period.

Therefore, the inventors thought out the following measure to lower the reactivity of the fuel assembly in the first period. By the measure, the reactivity of the fuel assembly in the second period can be increased, and thereby the usage efficiency of uranium can be improved. In addition, the maximum enrichment of uranium 235 is less than 10 wt % from the standpoint of the enrichment range used in an atomic power plant.

The measure found by the inventors is that fuel rods at the outermost layer in the fuel rod arrangement of the fuel assembly cross section have enrichment that is a certain value or more and is over an average enrichment of the fuel assembly cross section. A neutron spectrum at the outermost layer, which faces the water gap formed between the fuel assemblies in the core, in the fuel rod arrangement is softer than a neutron spectrum in a region located on the inside of the outermost layer. Therefore, mean free paths of neutrons become short, and a fission-cross sectional area at the fuel pellet surface contracted by the neutron spectrum becomes large at the outermost layer. For that reason, the fissile material (such as uranium 235) contained in the nuclear fuel material burns at the surface of each fuel pellet included in the fuel rods. When the amount of fissile material at the surface of the fuel pellet increases, moderated neutrons become difficult to reach the inside of the fuel pellet. Enrichment increase of the fuel pellet causes increase of the fissile material per unit volume of the fuel pellet, and moderated neutrons become further difficult to reach the inside of the fuel pellet because of neutron shielding effect by the fissile material existing at the surface part of the pellet. By heightening the enrichment of the fuel rods arranged at the outermost layer in the fuel rod arrangement of the fuel assembly cross section compared to that of the fuel rods arranged at the outermost layer of the publicly known peripheral peak type fuel assembly, in the first period, the nuclear fission occurs at the surface of the fuel pellet and the nuclear fission is restrained in the center part of the fuel pellet by neutron shielding effect of the fissile material. After the burnable poison has perished, in other word, in a state where the fissile material at the surface of the fuel pellet in the fuel rod arranged at the outermost layer has burnt and the fissile material content at the surface has become low, the moderated neutrons become easier to reach the center part of the fuel pellet, and thereby the nuclear fission becomes active in the center part of the fuel pellet. Therefore, by increasing the enrichment of the fuel rod arranged at the outermost layer and utilizing the neutron shielding effect, even when the burnable poison content of the fuel rod is reduced, the reactivity of the fuel assembly can be restrained in the first period, and the reactivity of the fuel assembly can be increased after the burnable poison has perished.

The inventors set specific average enrichment at the outermost layer of the fuel assembly of the present invention, wherein the specific average enrichment thereof is not corresponding to that of an outermost layer of a conventional non-peripheral peak type fuel assembly and that of the conventional peripheral peak type fuel assembly, and the specific average enrichment of the present invention is further increased compared to that of the conventional peripheral peak type fuel assembly. Then, on such conditions, the inventors studied a change of difference between the infinite multiplication factor of the peripheral peak type fuel assembly of the present invention and the infinite multiplication factor of the conventional non-peripheral peak type fuel assembly due to burnup. In an example of the conventional non-peripheral fuel assembly, the average enrichment of the fuel assembly is 4.5 wt %, the average enrichment of the outermost layer is 4.0 wt %, and the average enrichment in the region located on the inside of the outermost layer is 4.82 wt %. In an example of the peripheral peak type fuel assembly of the present invention, the average enrichment of the fuel assembly is the same as the conventional non-peripheral peak type fuel assembly of 4.5 wt %, the average enrichment of the outermost layer is 5.27 wt %, and the average enrichment in the region located on the inside of the outermost layer is 4.0 wt %. In the conventional non-peripheral fuel assembly, the ratio of the average enrichment of the outermost layer to the average enrichment of the cross section of the fuel assembly is 0.9. On the other hand, in the peripheral peak type fuel assembly of the present invention, the ratio of the average enrichment of the outermost layer to the average enrichment of the cross section of the fuel assembly is 1.17. Incidentally, in the conventional peripheral peak type fuel assembly described in Japanese Patent Laid-open No. Sho 58 (1983)-26292, average enrichment of upper cross section of the fuel assembly is 3.08 wt % and the ratio described above is 1.13 at the upper cross section. In the peripheral peak type fuel assembly of the present invention, when the average enrichment of the cross section is 3 wt %, the ratio becomes 1.4 or larger. Both the conventional non-peripheral fuel assembly and the peripheral peak type fuel assembly of the present invention having been studied do not contain gadolinium.

The inventors obtained the change of the infinite multiplication factor difference described above against burnup when these fuel assemblies are loaded in the core and the fissile material in each fuel assembly is burnt. The results are shown in FIG. 5. These are the results when the average void fraction in the channel box is presumed to be the average void fraction in the core of 40%. In FIG. 5, the vertical axis shows the infinite multiplication factor difference obtained by subtracting the infinite multiplication factor of the conventional fuel rod (of the non-peripheral peak type) from the infinite multiplication factor of the peripheral peak type fuel assembly of the present invention. The horizontal axis shows the burnup of each fuel assembly compared to each other. By heightening the enrichment of the fuel rods arranged at the outermost layer compared to that of the conventional fuel assembly, the reactivity of the fuel assembly can be improved without changing the average enrichment of the fuel assembly cross section. In the peripheral peak type fuel assembly of the present invention, as shown by the solid line, the reactivity of the fuel assembly increase by 0.1% Δk or more, at the position where the infinite multiplication factor difference becomes its peak due to burnup exceeds the reactivity increase at 0 GWd/t of the time point when the new fuel assembly is loaded in the core. Moreover, also at 25 GWd/t that is about half of the discharge burnup of the fuel assembly with average enrichment of 4.5 wt %, the infinite multiplication factor difference is improved according to the present invention.

In FIG. 5, the dotted line shows a characteristic of the conventional peripheral peak type fuel assembly. The average enrichment of the cross section of the peripheral peak type fuel assembly of the present invention is larger than that of the conventional peripheral peak type fuel assembly, and the average enrichment of the outermost layer of the peripheral peak type fuel assembly of the invention is larger than that of the outermost layer of the conventional peripheral peak type fuel assembly. For that reason, in the peripheral peak type fuel assembly of the present invention, the neutron shielding effect of the fissile material at the surface of the fuel pellets in the fuel rods becomes larger than that of the conventional peripheral peak type fuel assembly. Consequently, in the peripheral peak type fuel assembly of the present invention, the infinite multiplication factor difference during the period in which the burnup is 0 GWd/t to 50 GWd/t becomes larger than that of the conventional peripheral peak type fuel assembly, and, moreover, in the peripheral peak type fuel assembly of the invention, the reactivity increase at the position where the infinite multiplication factor difference reaches the peak can be 0.1% Δk or more. In contrast, in the conventional peripheral peak type fuel assembly, such a peak of the infinite multiplication factor difference can not be formed.

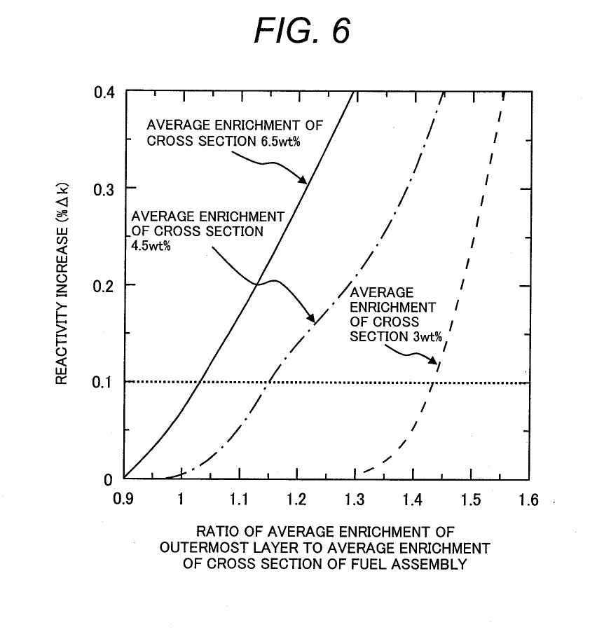

Moreover, the inventors studied a range of enrichment in which the reactivity can be restrained in the first period (before the burnable poison has perished) and the reactivity can be increased in the second period (after the burnable poison has perished) by decreasing a concentration of the burnable poison. As described above, in the general enrichment distribution of the conventional fuel assembly, the ratio of the average enrichment of the plural fuel rods arranged at the outermost layer to the average enrichment of the fuel assembly cross section is approx. 0.9. With reference to the enrichment distribution with the ratio of approx. 0.9, the inventors studied as to a change of an increase of the infinite multiplication factor by setting the average enrichment of the fuel assembly cross section to be 3 wt %, 4.5 wt % and 6.5 wt % respectively and changing the ratio of the average enrichment of the outermost layer to each of the average enrichments of the fuel assembly cross section with 3 wt %, 4.5 wt % and 6.5 wt %. The increase of the infinite multiplication factor is called as a reactivity increase. In the inventers' study, after loading those three sorts (3 wt %, 4.5 wt % and 6.5 wt %) of fuel assemblies in the core as new fuel assemblies (0 GWd/t) respectively, and obtaining the reactivity increase as a difference between the maximum reactivity at the time when the maximum reactivity appears in the first operation cycle (Namely the maximum reactivity appears after those fuel assemblies are loaded in the core as new fuel and after nuclear reactor operation is started) and the reactivity of the new fuel assembly at the beginning of operation. The reactivity increase is shown in FIG. 6 per average enrichment of cross section of three fuel assemblies. A horizontal axis shows the ratio of the average enrichment of the outermost layer to the average enrichment of the fuel assembly cross section. Provided that the reactivity increase is less than 0.1% Δk, the peak of the reactivity increase is formed during the first period for the fuel assembly loaded in the core with burnup 0 GWd/t, that is, during the period before gadolinium as the burnable poison has perished. Provide that the reactivity increase is 0.1% Δk or more, the peak of the reactivity increase appears during the second period, that is, after gadolinium contained in the fuel assembly loaded in the core has perished.

When the average enrichment of cross section of the fuel assembly loaded in the core with burnup 0 GWd/t is 3.0 wt %, provided that the ratio of the average enrichment of the outermost layer to the average enrichment of the cross section is less than 1.43, the peak of the reactivity increase appears in the first period for the fuel assembly. In this case, in the second period after gadolinium contained in the fuel assembly with the average enrichment 3.0 wt % of the cross section has perished, the maximum reactivity increase is not significant in comparison to that of the first period of the fuel assembly. Even when the average enrichment of cross section of the fuel assembly with burnup 0 GWd/t is 3.0 wt %, provided that the ratio of the average enrichment of the outermost layer to the average enrichment of the cross section is 1.43 or more, with reduced concentration of the burnable poison in the fuel assembly, the reactivity can be restrained in the first period (before the burnable poison has perished), and the reactivity can be increased in the second period (after the burnable poison has perished). When the average enrichment of cross section of the fuel assembly with burnup 0 GWd/t is 4.5 wt %, provided that the ratio of the average enrichment of the outermost layer to the average enrichment of the cross section is 1.13 or more, with reduced concentration of the burnable poison in the fuel assembly, the reactivity can be restrained in the first period (before the burnable poison has perished), and the reactivity can be increased in the second period (after the burnable poison has perished). When the average enrichment of cross section of the fuel assembly with burnup 0 GWd/t is 6.5 wt %, provided that the ratio of the average enrichment of the outermost layer to the average enrichment of the cross section is 1.04 or more, those effects also can be obtained.

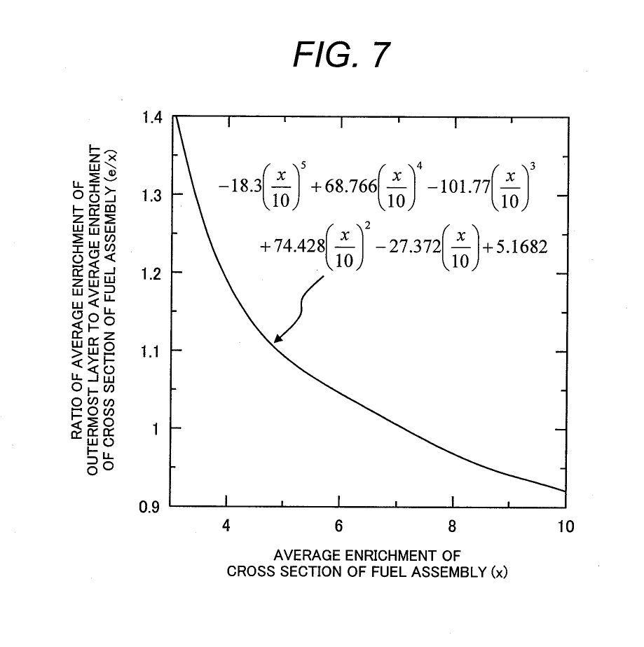

Then, the inventors studied a lower limit of the ratio of the average enrichment of the outermost layer to the average enrichment of the cross section, namely the lower limit with which the above-mentioned effects (effects of the concentration of the burnable poison being reduced, the reactivity being restrained in the first period, and the reactivity being increased in the second period) appear. As a result of the study, when the average enrichment of the fuel assembly cross section is expressed by x (wt %), and the average enrichment of the outermost layer of the fuel assembly is expressed by e (wt %), the relation between the ratio (e/x) of the average enrichment of the outermost layer e (wt %) to the average enrichment of the fuel assembly cross section x (wt %) and the average enrichment x (wt %) is obtained as shown in FIG. 7. The characteristic shown in FIG. 7 can be expressed by equation (3).

$$\begin{matrix}[ Equation 3 ] & \\ \frac{e}{x} = - 18.3 {( \frac{x}{10} )}^{5} + 68.766 {( \frac{x}{10} )}^{4} - 101.77 {( \frac{x}{10} )}^{3} + 74.428 {( \frac{x}{10} )}^{2} - 27.372 ( \frac{x}{10} ) + 5.1682 & ( 3 )\end{matrix}$$

The ratio e/x obtained by the equation (3) shows the lower limit of the ratio of the average enrichment of the outermost layer to the average enrichment of the fuel assembly cross section, namely the lower limit with which the above-mentioned effects (effects of the concentration of the burnable poison being reduced, the reactivity being restrained in the first period, and the reactivity being increased in the second period) appear. Equation (3) shows that when the average enrichment x (wt %) of the horizontal axis becomes high enrichment (7 wt % or more), the ratio e/x of the vertical axis becomes 1 or less. Even in the state where the average enrichment of the outermost layer is smaller than the average enrichment of the fuel assembly cross section, above-mentioned effects of the concentration of the burnable poison being reduced, the reactivity being restrained in the first period, and the reactivity being increased in the second period occur. This is because the average enrichment of the fuel assembly cross section is high enrichment of 7 wt % or more, and for both fuel rods arranged at the outermost layer and fuel rods arranged in the region located on the inside of the outermost layer, the moderated neutrons become difficult to reach the center part of the pellet due to the neutron shielding effect by the fissile material existing at the surface part of the pellets in each of the fuel rods. Especially, in this case, since (i) the enrichment of the fuel rods arranged in the region located on the inside of the outermost layer is higher than the enrichment of the fuel rods arranged at the outermost layer, and (ii) the quantity of water existing around the fuel rods arranged in the region located on the inside of the outermost layer is less than the quantity of water that exists around the fuel rods arranged at the outermost layer. Therefore, in the fuel rods arranged in the region located on the inside of the outermost layer, by the combination of the above-mentioned (i) (ii) and the neutron shielding effect by the fissile material at the surface part of the pellets, the neutrons become further difficult to reach the center part of the fuel pellet, and the usage efficiency of the fissile material in the center part of the fuel pellet declines. In contrast, in the fuel rods arranged at the outermost layer, since the neutron shielding effect is smaller than that of the fuel rods arranged in the region located on the inside of the outermost layer due to the lower enrichment compared to the fuel rods arranged in the region located on the inside of the outermost layer and more incident thermal neutrons from the water gap are supplied, the reactivity of the outermost layer becomes higher than that in the region located on the inside of the outermost layer. For that reason, since the fuel assembly in which average enrichment x (wt %) is 7 wt % or more and ratio e/x is 1 or less substantially functions as the peripheral peak type fuel assembly of the invention, the concentration of the burnable poison can be reduced, the reactivity can be restrained in the first period, and the reactivity of the fuel assembly can be increased in the second period. Accordingly, even when the average enrichment x (wt %) is 7 wt % or more and the ratio e/x is 1 or less, the burnable poison content of the fuel assembly can be reduced and the economical efficiency of nuclear fuel is improved.

The ratio e/x needs to satisfy the above-mentioned equation (1) to obtain the effects of the concentration of the burnable poison in the fuel assembly being reduced, the reactivity being restrained in the first period (before the disappearance of the burnable poison), and the reactivity being increased in the second period, by utilizing the neutron shielding effect of the fissile material at the surface part of the fuel pellets in the fuel rods arranged at the outermost layer. Here, above-mentioned equation (1) is described once again.

$$\begin{matrix}[ Equation 4 ] & \\ \frac{e}{x} \geq - 18.3 {( \frac{x}{10} )}^{5} + 68.766 {( \frac{x}{10} )}^{4} - 101.77 {( \frac{x}{10} )}^{3} + 74.428 {( \frac{x}{10} )}^{2} - 27.372 ( \frac{x}{10} ) + 5.1682 & ( 1 )\end{matrix}$$

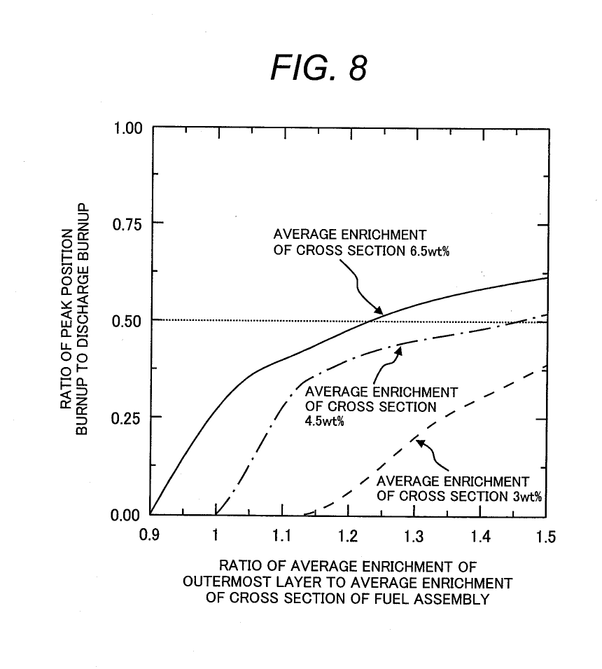

Next, the inventors studied a range in which the peak with the reactivity increase of 0.1% Δk or more in comparison with the reactivity of the peripheral peak type fuel assembly of the invention loaded in the core at the burnup of 0 GWd/t can be obtained in a operation cycle after the first operation cycle of the fuel assembly (for example, the second operation cycle). In each of the average enrichments 3 wt %, 4.5 wt %, and 6.5 wt % of the fuel assemblies, the ratio of the burnup at which the peak of the reactivity shown in FIG. 5 occurs to a general discharge burnup is shown in FIG. 8 in correlation with the ratio of the average enrichment of the outermost layer to the average enrichment of the fuel assembly cross section. When the fuel assembly loaded in the core is exchanged by two batches, the first operation cycle for the new fuel assembly loaded in the core is finished at the point of time when the burnup becomes half (0.5) of the discharge burnup of the fuel assembly. Therefore, it is preferable to form the peak of the reactivity increase formed in the range of the burnup more than half (0.5) of the discharge burnup. As the average enrichment of cross section of the fuel assembly becomes higher, the concentration of the burnable poison in the fuel assembly can be reduced, the reactivity can be restrained in the first period, and the reactivity can be increased in the second period, even when the ratio of the average enrichment of the outermost layer to the average enrichment of the cross section declines. In addition, at a certain average enrichment of the cross section, when comparing the average enrichment of the outermost layer on the solid line of equation (1) to the average enrichment of the outermost layer where the ratio of the burnup at the peak position to the discharge burnup in FIG. 8 becomes 0.5, the average enrichment of the later outermost layer is larger than that of the former outermost layer.

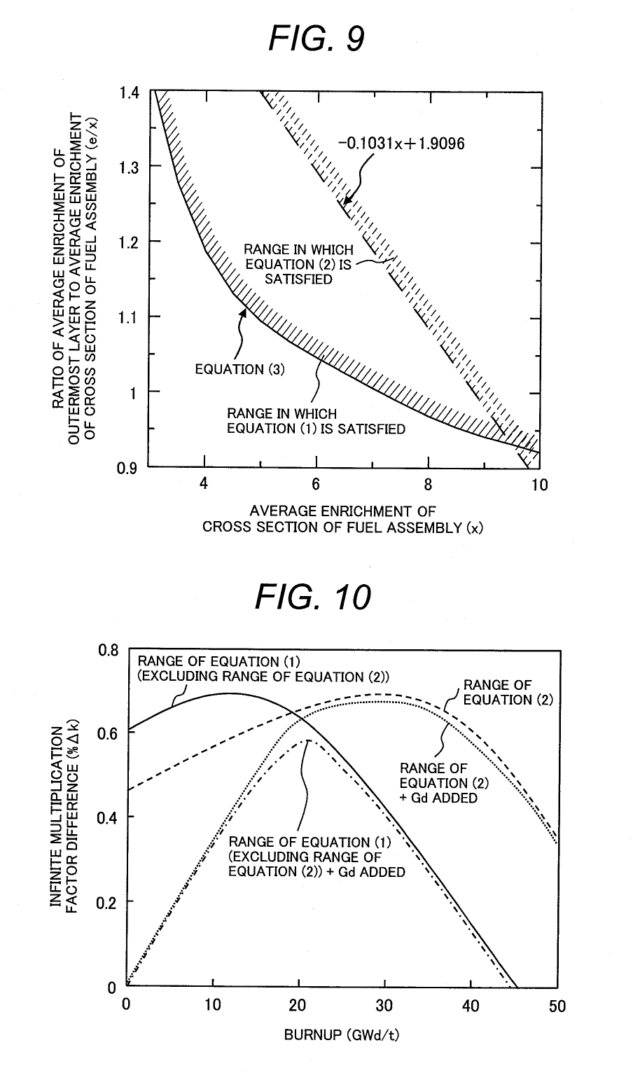

Dotted line shown in FIG. 9A expresses of a lower limit of the ratio e/x where the peak of the reactivity increase is formed in the range of the burnup more than half (0.5) of the discharge burnup of the fuel assembly by the neutron shielding effect of the fissile material. The relation between the average enrichment of the fuel assembly cross section x (wt %) and the ratio e/x is shown by a dotted line and expressed by equation (4).

$$\begin{matrix}[ Equation 5 ] & \\ \frac{e}{x} = - 0.1031 x + 1.9096 & ( 4 )\end{matrix}$$

When the ratio e/x of the average enrichment of the outermost layer to the average enrichment of the fuel assembly cross section is larger than the value obtained by equation (4), that is, equation (2) above is satisfied, the above-mentioned advantages of the present invention are further increased. Here, above-mentioned equation (2) is described once again.

$$\begin{matrix}[ Equation 6 ] & \\ \frac{e}{x} \geq - 0.1031 x + 1.9096 & ( 2 )\end{matrix}$$

Here, explanation is done by using FIG. 10 as to differences of advantages obtained when equation (1) is satisfied and when equation (2) is satisfied. “Range of equation (1) (excluding range of equation (2))” shown by the solid line in FIG. 10 corresponds to the range between solid line and dashed line in FIG. 9. The new fuel assembly (or assemblies) loaded in the core contain burnable poison to restrain excess reactivity. Since the new fuel assembly contains burnable poison (such as gadolinium), the relations between the burnup and the above-mentioned infinite multiplication factor difference transfer from “range of equation (1) (excluding range of equation (2))” shown by the solid line to “range of equation (1) (excluding equation (2))+Gd added” shown by the alternate long and short dashed line, and from “range of equation (2)” shown by the dashed line to “range of equation (2)+Gd added” shown by the dotted line. These characteristics are for the fuel assembly containing gadolinium under the condition that the peak heights obtained by equation (1) and equation (2) are the same, and one operation cycle period is 20 GWd/t (gadolinium perishes at 20 GWd/t). In the case of equation (1), the peak value decreases by the addition of gadolinium, but in the case of equation (2), the peak value does not decrease so much by the addition of gadolinium.

The above-mentioned explanation will be described further specifically. The peak height of solid line of “range of equation (1) (excluding range of equation (2))” is the same as that of the dashed line of “range of equation (2)”. In other words, gain effects against the conventional fuel assembly seem to be the same at this stage. However, actually, since Gd is added to the peripheral peak type fuel assembly of the present invention, the infinite multiplication difference changes against the burnup as “range of equation (2)+Gd added” shown by the dotted line in FIG. 10. At this time, when the peak heights are compared to each other, “range of equation (2)” is higher than “range of equation (1)”. In other words, in the case of the peripheral peak type fuel assembly of the invention, the burnup increase effect becomes large when “range of equation (2)” is applied. In FIG. 10, restraint at the burnup 0 GWd/t in “range of equation (1) (excluding range of equation (2))+Gd added” and “range of equation (2)+Gd added” is equivalent to that of the conventional fuel assembly. At the point of time of 0 GWd/t, since the infinite multiplication factor difference in “range of equation (2)” shown by the dashed line is smaller than that in “range of equation (1) (excluding range of equation (2)” shown by the solid line, the additive amount of gadolinium is small in “range of equation (2)”. Therefore, the gadolinium content (burnable poison content) contained in the fuel assembly 1A at burnup 0 GWd/t can be reduced, the reactivity can be further restrained before the burnable poison has perished, and the reactivity can be further increased after the burnable poison has perished.

Moreover, the inventors studied remedies for deterioration of thermal margin caused by a bias of the power peak to the outermost layer. The deterioration of thermal margin is caused on the surface of the fuel rods contacting with a gas-liquid two-phase flow flowing in the channel box because a liquid film covering each surface of the fuel rods thins down. In particular, the liquid film of the fuel rods with large power trends to thin down. The liquid film on the surface of the fuel rod tends to form at the upper part of the fuel rod. Thus, in the fuel rod, the hardest position in the thermal margin is the downstream side in a flow direction of the gas-liquid two-phase flow. Therefore, for improving the bias of the power peak to improve the thermal margin, the enrichment is preferably lowered at the upper part of the fuel assembly in the fuel rods at the outermost layer, or the fuel rods arranged at the outermost layer are preferably made to be partial length fuel rods not to produce heat at the upper part of the fuel assembly (the state in which the fuel rods do not exist).

Embodiments of the present invention that reflect the above-mentioned results of study will be described below.

### Embodiment 1

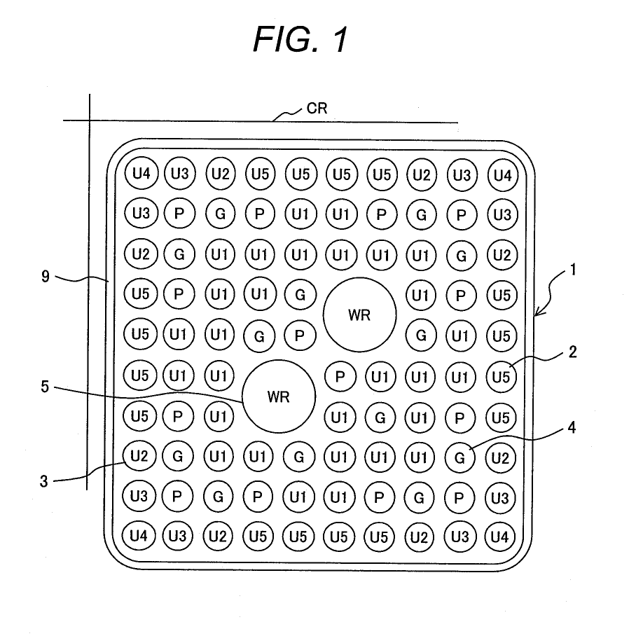

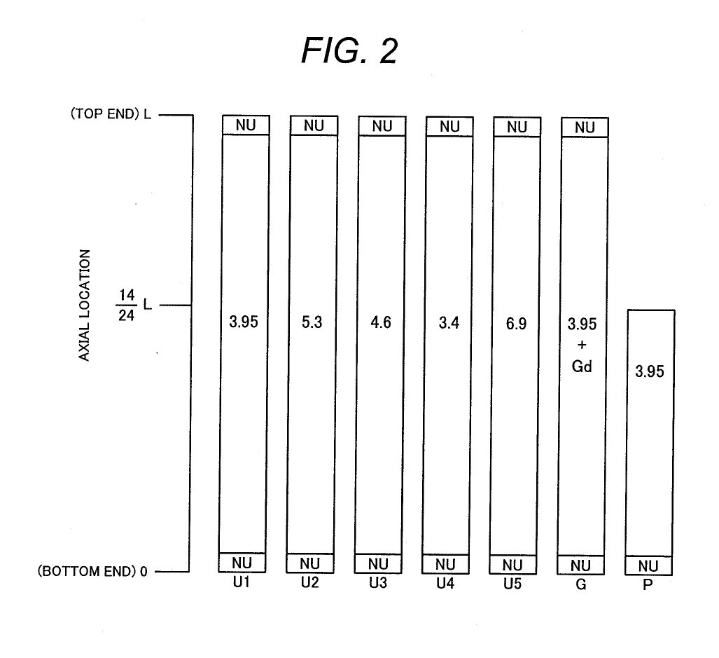

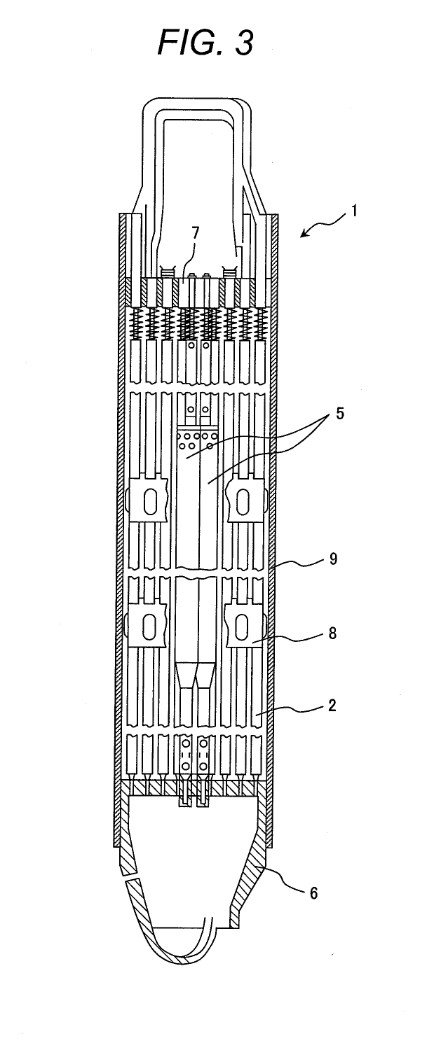

A fuel assembly of Embodiment 1 as a preferable embodiment of the present invention and applied to a BWR will be detailed with reference to FIG. 1, FIG. 2, and FIG. 3.

As shown in FIG. 3, a fuel assembly (1) comprises plural fuel rods (2), two water rods (5), a lower tie plate (6), an upper tie plate (7), plural fuel spacer (8), and a channel box (9). In the fuel rod (2), plural fuel pellets (not shown) are filled up into a hermetically sealed cladding tube (not shown). The lower tie plate (6) supports a bottom end of each fuel rod (2), and the upper tie plate (7) supports a top end of each fuel rod (2). As shown in FIG. 1, the fuel rods (2) are arranged in 10 rows by 10 columns in a cross section of the fuel assembly (1). Two water rods (5), each of which has a cross section area occupying a region in which four fuel rods (2) can be arranged, are arranged at a central part of the cross section. The bottom end of the water rods (5) is supported by the lower tie plate (6), and the top end of each of the water rods (6) is retained by the upper tie plate (7). The plural fuel spacers (8) are arranged at specified intervals in the axial direction of the fuel assembly (1), and retain the fuel rods (2) and the water rods (5) so as to form flow path in which cooling water flows through between the fuel rods (2) and between the fuel rod (2) and the water rod (5). The channel box (9), which is a rectangular cylinder whose cross section is square, is fixed to the upper tie plate (7) and extends downward. The fuel rods (2) bound by the fuel spacers (8) are arranged in the channel box (9). In addition, an outer width of the channel box (9) is approx. 15 cm, an outer diameter of the fuel rod (2) is approx. 1.0 cm, and the outer diameter of the water rod (5) is approx. 2.5 cm. The water rods (5) are large bore water rods each of which has a cross section area occupying a region where two fuel rods (2) can be arranged. In the fuel rods (2) of the embodiment, a length in an axial direction of the region where fuel pellets containing fissile uranium is loaded, that is, fuel effective length, is 3.7 m.

The fuel assembly (1), when being loaded in the core of the BWR, is arranged so that one corner of the fuel assembly (1) faces a control rod (CR) of whose cross section is a cross-like figure. The channel box (9) is fixed to the upper tie plate (7) with a channel fastener (not shown). The channel fastener has a function to keep a distance required between the fuel assemblies (1) so that the control rods CR can be inserted between the fuel assemblies (1) when the fuel assemblies (1) are loaded in the core. For this reason, the channel fastener is fixed to the upper tie plate (7) so that the channel fastener is located at a corner facing the control rod CR. In the fuel assembly (1), the corner thereof facing the control rod CR corresponds to, in other words, the corner where the channel fastener is fixed.

Each fuel pellet filled up into each fuel rod (2) is produced by using uranium dioxide as a nuclear fuel material, and contains uranium 235 as a fissile material. A plurality of plural fuel rods (2) in the fuel assembly (1) includes plural fuel rods containing uranium and not containing gadolinium as burnable poison (hereinafter referred to as a uranium fuel rod) and plural fuel rods containing uranium and gadolinium (hereinafter referred to as a burnable poison inclusion fuel rod). The fuel pellets of the burnable poison inclusion fuel rod (4) contain gadolinium respectively. The fuel rods other than the burnable poison inclusion fuel rods (4) are uranium fuel rods (3). Out of 92 fuel rods (2), 79 are uranium fuel rods (3), and the remaining 13 are the burnable poison inclusion fuel rods (4). The fuel assembly (1) includes, as shown in FIG. 1, fuel rods U1, U2, U3, U4, U5, G, and P as fuel rods (2). The fuel rods U1, U2, U3, U4, U5, and P are the uranium fuel rods (3), and the fuel rods G are the burnable poison inclusion fuel rods (4). In addition, the fuel rods (P) are partial length fuel rods. The burnable poison inclusion fuel rods (4) are not located at the outermost layer but located at second, third, and fourth layers from the outside.

The fuel assembly (1) has blanket regions at a top end and a bottom end of the fuel effective length, and a concentrated uranium region between blanket regions at the top end and the bottom end. In both blanket regions, not concentrated uranium but natural uranium is filled up. The blanket regions do not contain gadolinium, and the concentrated uranium region contains gadolinium.

Enrichment distribution of the uranium fuel rods (3) (fuel rods U1, U2, U3, U4, U5, and P fuel rods) will be detailed with reference to FIG. 21. Each of fuel rods U1, U2, U3, U4, U5, G, and P has a natural uranium region NU into which natural uranium is filled up at the bottom end of the fuel effective length. Each of fuel rods U1, U2, U3, U4, U5, and G has a natural uranium region where natural uranium is filled up at the top end of the fuel effective length. The fuel rod G contains gadolinium that is the burnable poison in the concentrated uranium region. Enrichment of each concentrated uranium region of the fuel rods U1, G, and P is 3.95 wt %. Enrichments of concentrated uranium regions of the fuel rods U2, U3, U4, and U5 are 5.3 wt %, 4.6 wt %, 3.4 wt %, and 6.9 wt %, respectively.

In a cross section of the concentrated uranium region of the fuel assembly (1), an average enrichment of the cross section at a lower portion of the concentrated uranium region (the lower portion where the partial length fuel rods P exist) is approx. 4.6 wt %, and an average enrichment of the cross section at a upper portion of the concentrated uranium region (the upper portion where the partial length fuel rods P do not exist) is approx. 4.7 wt %. The lower portion of the concentrated uranium region exists between a position of 1 L/24 from the bottom end of the fuel effective length and a position of 14 L/24 from the bottom end of the fuel effective length. Here, L is the fuel effective length in the axial direction. The upper portion of the concentrated uranium region exists between a position of 14 L/24 from the bottom end of the fuel effective length and a position of 23 L/24 from the bottom end of the fuel effective length. Average enrichments of the fuel rods arranged at the outermost layer of the fuel rod arrangement of the fuel assembly (1) are approx. 5.6 wt % both in the upper portion and lower portion thereof. In the fuel assembly (1), the ratio e/x of the average enrichment of the outermost layer e (wt %) to the average enrichment of the concentrated uranium region cross section x (wt %) are 1.19 at the upper portion of the fuel assembly (1), and 1.22 at the lower portion of the fuel assembly (1). The fuel assembly (1) is the peripheral peak type fuel assembly.

By substituting the average enrichment 4.6 wt % of the lower portion of the concentrated uranium region in the fuel assembly (1) into equation (3), the ratio e/x of the lower portion of the concentrated uranium region is determined to be 1.12. Accordingly, the ratio e/x (=1.22) of the lower portion of the concentrated uranium region in the fuel assembly (1) is larger than the ratio e/x (=1.12) obtained by equation (3), and satisfies equation (1). By substituting the average enrichment 4.7 wt % of the upper portion of the concentrated uranium region in the fuel assembly (1), the ratio e/x of the upper portion of the concentrated uranium region in the fuel assembly (1) is determined to be 1.11. Accordingly, the ratio e/x (=1.19) of the upper portion of the concentrated uranium region in the fuel assembly (1) is larger than the ratio e/x (=1.11) obtained by equation (3), and satisfies equation (1).

According to the embodiment, since equation (1) is satisfied, gadolinium content contained in the fuel assembly (1) at burnup 0 GWd/t can be reduced, reactivity of the fuel assembly (1) in the first period (before gadolinium in the fuel assembly (1) has perished) can be restrained, and reactivity of the fuel assembly (1) in the second period (after gadolinium in the fuel assembly (1) has perished) can be increased. In the embodiment, on-peak reactivity after gadolinium has perished (the on-peak reactivity is formed by satisfying equation (1)) can be increased by 0.14% Ak over the reactivity of the fuel assembly (1) at burnup 0 GWd/t when loaded in the core. As a result, the fuel assembly (1) of the embodiment can increase a discharge burnup by approximately 2% and can improve a utilization efficiency of uranium by 2%.

### Embodiment 2

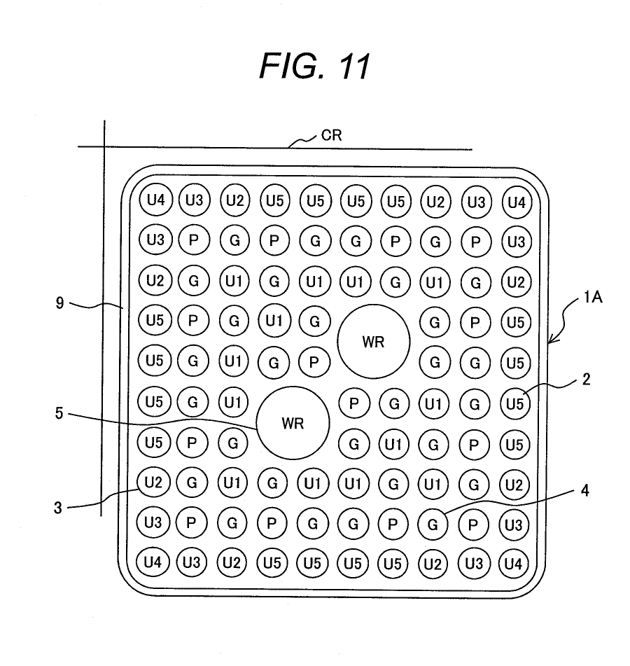

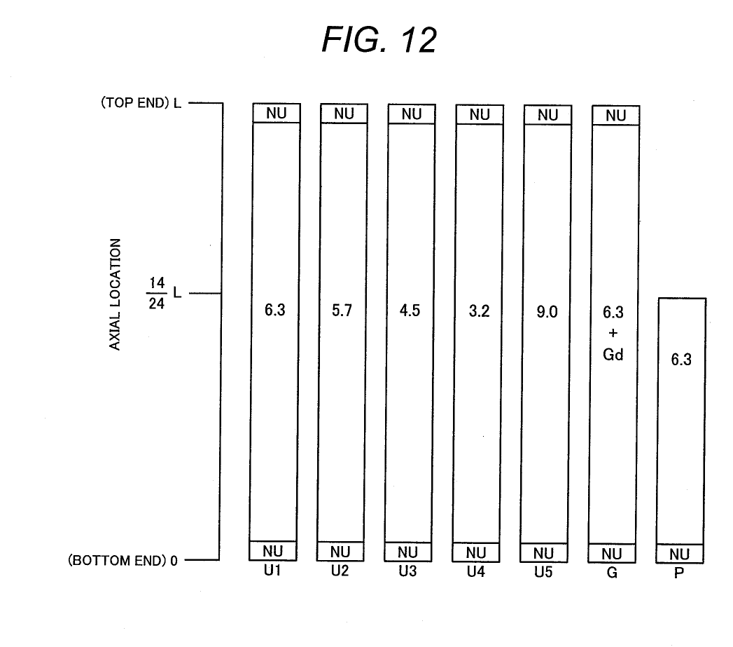

A fuel assembly of Embodiment 2 as another embodiment of the present invention to be applied to a BWR, will be described with reference to FIG. 11 and FIG. 12. A fuel assembly (1A) of the embodiment has a constitution where enrichment of the concentrated uranium region in each of the fuel rods U1, U2, U3, U4, U5, G, and P corresponding to that of the fuel assembly (1) in Embodiment 1 is changed as follows. The enrichments of the concentrated uranium region of the fuel rods U1, U2, U3, U4, U5, G, and P are, as shown in FIG. 12, 6.3 wt %, 5.7 wt %, 4.5 wt %, 3.2 wt %, 9.0 wt %, 6.3 wt %, and 6.3 wt % respectively. The arrangement of the fuel rods U1, U2, U3, U4, U5, G, and P in the cross section of the fuel assembly (1A) is the same as the arrangement in the cross section of the fuel assembly (1). The constitution of the fuel assembly (1A) other than above is the same as the fuel assembly (1).

In the cross section of the concentrated uranium region of the embodiment, both the average enrichment of the cross section of the lower portion thereof where the partial length fuel rods P exist and the average enrichment of the cross section of the upper portion thereof where the partial length fuel rods P do not exist, are approximately 6.4 wt %. Average enrichments of the fuel rods arranged at the outermost layer of the fuel rod arrangement of the fuel rod (1A) are approximately 6.6 wt % both in the upper portion and lower portion. In the fuel assembly (1A), the ratios e/x of the average enrichment of the outermost layer e (wt %) to the average enrichment of the concentrated uranium region cross section x (wt %) are 1.031 both at the upper portion and the lower portion of the fuel assembly (1A). The fuel assembly (1A) is a peripheral peak type fuel assembly.

By substituting the average enrichment 6.4 wt % of the upper and lower portions of the concentrated uranium region in the fuel assembly (1A) into equation (3), the ratio e/x of the upper and lower portions of the concentrated uranium region in the fuel assembly (1A) is determined to be 1.030. Accordingly, the ratio e/x (=1.031) of the upper and lower portions at the outermost layer of the concentrated uranium region in the fuel assembly (1A) is larger than the ratio e/x (=1.030) obtained by equation (3), and satisfies equation (1).

The embodiment has a constitution where the burnup of the fuel assembly can be heightened by increasing the average enrichment of the cross section of the fuel assembly (1A) and the utilization efficiency of uranium can be improved. Since the embodiment also satisfies the equation (1), the gadolinium content contained in the fuel assembly (1A) at burnup 0 GWd/t can be reduced, the reactivity of the fuel assembly (1A) in the first period can be restrained, and the reactivity of the fuel assembly (1A) in the second period can be increased. According to the embodiment, on-peak reactivity after gadolinium has perished (the on-peak reactivity is formed by satisfying equation (1)) can be increased by 0.1% Δk over the reactivity of the fuel assembly (1A) at burnup 0 GWd/t in the core. As a result, the fuel assembly (1A) of the embodiment can increase the discharge burnup by approximately 1% and can improve the utilization efficiency of uranium by 1%. Moreover, in the embodiment, since the ratio of the average enrichment of the outermost layer to the average enrichment of the fuel assembly cross section becomes small compared to Embodiment 1, the power peak at the outermost layer can be reduced more than Embodiment 1.

### Embodiment 3

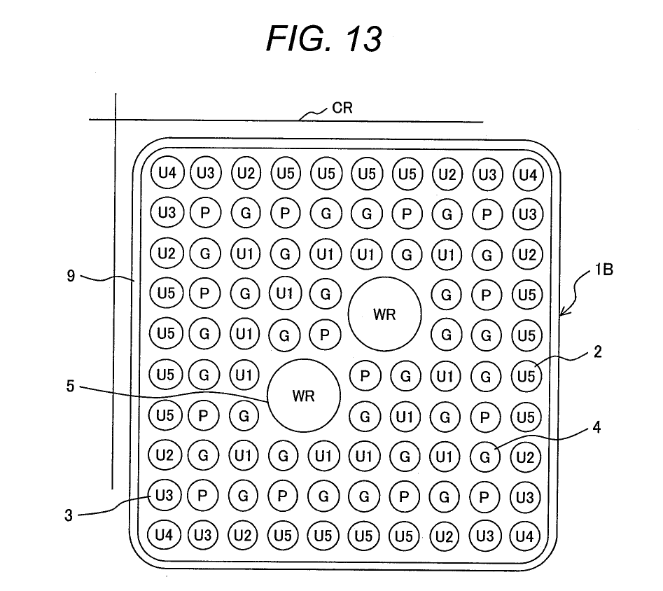

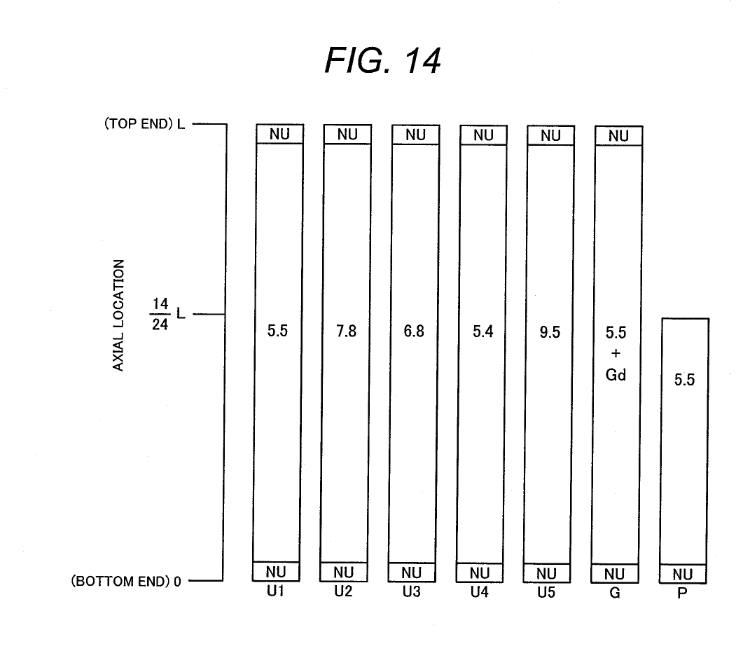

A fuel assembly of Embodiment 3 as another embodiment of the present invention to be applied to a BWR, will be described with reference to FIG. 13 and FIG. 14. A fuel assembly (1B) of the embodiment has a constitution where enrichment of the concentrated uranium region in each of the fuel rods U1, U2, U3, U4, U5, G, and P corresponding to that of the fuel assembly (1) in Embodiment 1 is changed as follows. The enrichments of the concentrated uranium region of the fuel rods U1, U2, U3, U4, U5, G, and P are, as shown in FIG. 14, 5.5 wt %, 7.8 wt %, 6.8 wt %, 5.4 wt %, 9.5 wt %, 5.5 wt %, and 5.5 wt % respectively. The constitution of the fuel assembly (1B) other than above is the same as the fuel assembly (1). The arrangement of fuel rods U1, U2, U3, U4, U5, G, and P in the cross section of the fuel assembly (1B) is the same as the arrangement in the cross section of the fuel assembly (1).

In the embodiment, both the average enrichment of the cross section of the lower portion where the partial length fuel rods P exist in the concentrated uranium region and the average enrichment of the cross section of the upper portion where the partial length fuel rods P do not exist in the concentrated uranium region, are approximately 6.5 wt %. Average enrichments of the fuel rods arranged at the outermost layer of the fuel rod arrangement in the fuel assembly (1B) are approximately 8.1 wt % both at the upper portion and the lower portion. In the fuel assembly (1B), the ratio e/x of the average enrichment of the outermost layer e (wt %) to the average enrichment of the concentrated uranium region cross section x (wt %) are 1.240 both at the upper portion and the lower portion of the fuel assembly (1B). The fuel assembly (1B) is a peripheral peak type fuel assembly.

By substituting the average enrichment 6.5 wt % of the upper and lower portions of the concentrated uranium region in the fuel assembly (1B) into equation (3), the ratio e/x of the upper and lower portions of the concentrated uranium region in the fuel assembly (1B) is determined to be 1.025. Accordingly, the ratio e/x (=1.240) of the upper and lower portions of the concentrated uranium region in the fuel assembly (1B) is larger than the ratio e/x (=1.025) obtained by equation (3), and satisfies equation (1).

Moreover, by substituting the average enrichment 6.5 wt % of the upper and lower portions of the concentrated uranium region in the fuel assembly (1B) into equation (4), the ratio e/x of the upper and lower portions of the concentrated uranium region in the fuel assembly (1B) is determined to be 1.239. Accordingly, the ratio e/x (=1.240) of the upper and lower portion of the concentrated uranium region in the fuel assembly (1B) is larger than the ratio e/x (=1.239) obtained by equation (4), and also satisfies equation (2). Therefore, the embodiment has a region where both equation (1) and equation (2) are satisfied.

Since the embodiment satisfies both equation (1) and equation (2), gadolinium content contained in the fuel assembly (1B) at burnup 0 GWd/t can be further reduced, reactivity of the fuel assembly (1B) in the first period can be further restrained, and reactivity of the fuel assembly (1B) in the second period can be further increased. In the embodiment, the gadolinium decreases more than in Embodiment 1, the reactivity in the first period is restrained more than in Embodiment 1, and the reactivity in the second period is increased more than in Embodiment 1. According to the embodiment, on-peak reactivity after gadolinium has perished (the on-peak reactivity is formed by satisfying equation (1) and equation (2)) can be increased by 0.3% Δk over the reactivity of the fuel assembly (1B) at burnup 0 GWd/t in the core. For that reason, the fuel assembly (1B) of the embodiment can increase discharge burnup by approximately 3% and can improve utilization efficiency of uranium by 3%. As a result, the embodiment can improve the economical efficiency of nuclear fuel by 3%, and can improve the economical efficiency of nuclear fuel more than Embodiment 1. Since the peak of the reactivity increase is formed in the burnup region of more than half of the discharge burnup of the fuel assembly (1B), the effect (improvement of the economical efficiency of nuclear fuel) can be obtained in the core operation end stage after gadolinium has perished.

### Embodiment 4

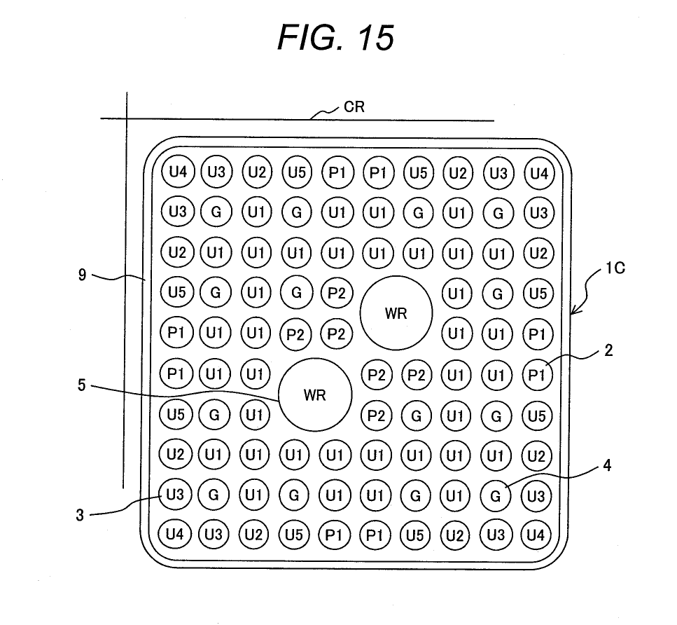

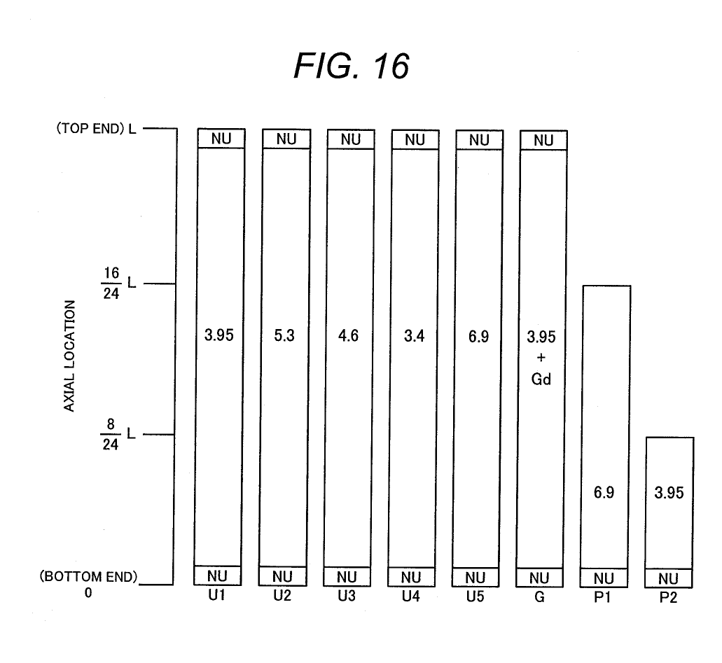

A fuel assembly of Embodiment 4 as another embodiment of the present invention to be applied to a BWR, will be described with reference to FIG. 15 and FIG. 16. A fuel assembly (10) of the embodiment has a constitution of two types of partial length fuel rods having lengths different from each other in an axial direction thereof and the partial length fuel rods being applied in the fuel assembly (1) of Embodiment 1. The constitution of the fuel assembly (10) other than above is the same as the fuel assembly (1A).

The fuel assembly (1C) has fuel rods U1, U2, U3, U4, U4, U5, G, P1, and P2. Enrichment distribution of each of the fuel rods U1, U2, U3, U4, U5, G, P1, and P2 is shown in FIG. 16. The enrichment of each concentrated uranium region of the fuel rods U1, U2, U3, U4, U5, and G in the fuel assembly (1C) is the same as that of the fuel rods U1, U2, U3, U4, U5, and G in the fuel assembly (1). The enrichment of concentrated uranium region of the partial length fuel rods P1 is 6.9 wt %, and the enrichment of concentrated uranium region of the partial length fuel rods P2 is 3.95 wt %. Eight of the partial length fuel rods P1 are arranged at the outermost layer. Six of the partial length fuel rods P2 are arranged adjacent to the water rods (5).

The top ends of the partial length fuel rods P used in the fuel assemblies (1), (1A), and (1B) are located at a position of 16 L/24 from the bottom end of the fuel effective length. On the other hand, the top ends of the partial length fuel rods P1 used in the embodiment are located at the position of 16 L/24 from the bottom end of the fuel effective length and the top ends of the partial length fuel rods P2 used in the embodiment are located at a position of 18 L/24 from the bottom end of the fuel effective length. Then, in the fuel assembly (10), the concentrated uranium region is divided into three portions in the axial direction by the top ends of the partial length fuel rods P1 and P2. A lower portion thereof is between a position of 1 L/24 from the bottom end of the fuel effective length and a position of 8 L/24 from the bottom end of the fuel effective length, a middle portion thereof is between the position of 8 L/24 from the bottom end of the fuel effective length and a position of 16 L/24 from the bottom end of the fuel effective length, and an upper portion thereof is between the position of 16 L/24 from the bottom end of the fuel effective length and a position of 23 L/24 from the bottom end of the fuel effective length.

The average enrichment of the lower portion cross section of the fuel assembly (1C) is 4.6 wt %, and the average enrichment of the outermost layer in the lower portion is 5.6 wt %. The middle portion is one where six partial length fuel rods P2 do not exist. The average enrichment of the middle portion cross section of the fuel assembly (1C) is 4.7 wt %, and the average enrichment of the outermost layer in the middle portion is 5.6 wt %. The upper portion is one where six partial length fuel rods P2 and eight partial length fuel rods P1 do not exist. The average enrichment of the upper portion cross section of the fuel assembly (1C) is 4.4 wt %, and the average enrichment of the outermost layer in the middle portion is 4.1 wt %. In the lower portion and the middle portion, the average enrichment of the respective outermost layers are larger than the average enrichments of the respective portion cross sections, but in the upper portion, the average enrichment of the outermost layer thereof is smaller than the average enrichment of the upper portion cross section.

In the embodiment, the ratio e/x (=1.224) of the lower portion of the concentrated uranium region is larger than the ratio e/x (=1.122) obtained by substituting the average enrichment 4.6 wt % of the lower portion cross section into equation (3). Accordingly, the lower portion of the concentrated uranium region satisfies equation (1). The ratio e/x (=1.211) of the middle portion of the concentrated uranium region is larger than the ratio e/x (=1.114) obtained by substituting the average enrichment 4.7 wt % of the middle portion cross section into equation (3). Accordingly, the middle portion of the concentrated uranium region satisfies equation (1). The ratio e/x 0.928 of the upper portion of the concentrated uranium region is smaller than the ratio e/x (=1.140) obtained by substituting the average enrichment 4.4 wt % of the upper portion cross section into equation (3). Accordingly, the upper portion of the concentrated uranium region does not satisfy equation (1).

In the embodiment, since equation (1) is satisfied in the lower portion and the middle portion, gadolinium content contained in the fuel assembly (1C) at burnup 0 GWd/t can be reduced, reactivity of the fuel assembly (1C) before gadolinium in the fuel assembly (10) has perished can be restrained, and reactivity of the fuel assembly (1C) after gadolinium in the fuel assembly (1C) has perished can be increased. Moreover, in the embodiment, since the partial length fuel rods P1 are arranged at the outermost layer, the partial length fuel rods do not exist at the upper portion of the outermost layer. Therefore, the thermal margin in the upper portion of the fuel assembly (10) is improved, thereby critical power of the fuel assembly (10) is improved.

### Embodiment 5

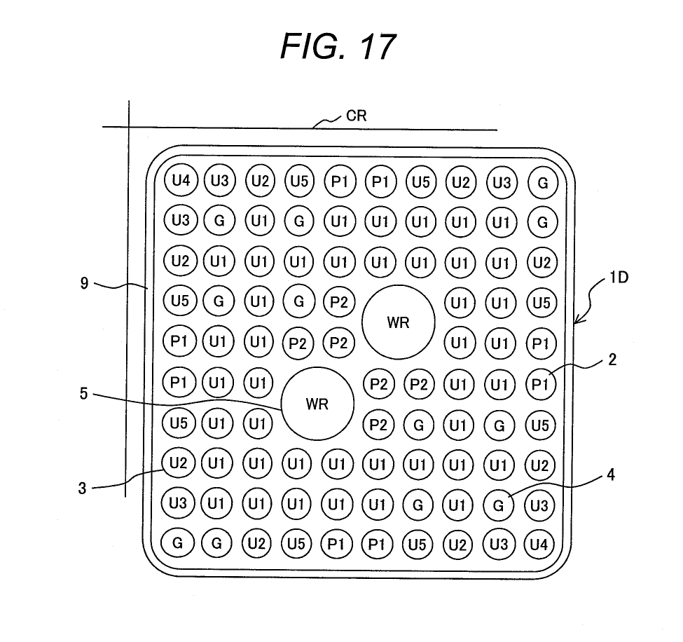

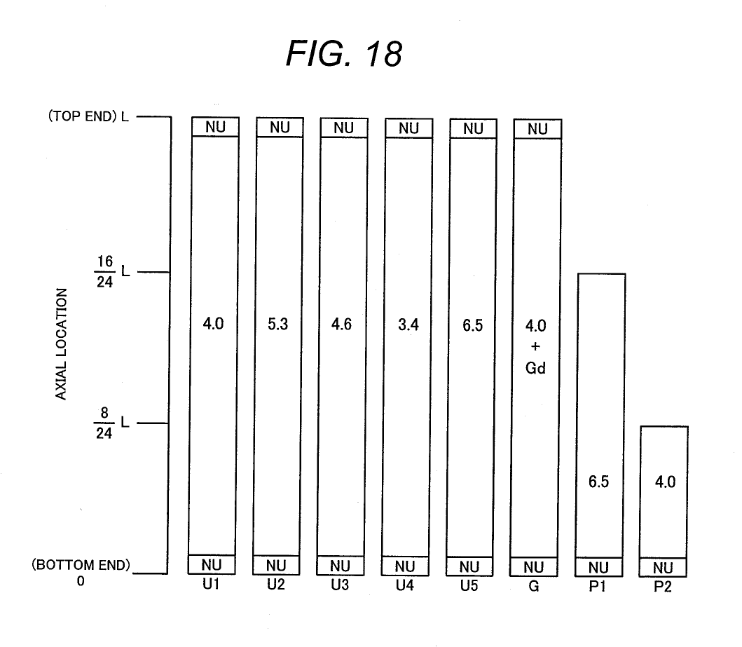

A fuel assembly of Embodiment 5 as another embodiment of the present invention to be applied to a BWR, will be described with reference to FIG. 17 and FIG. 18. A fuel assembly (1D) of the embodiment has the following constitution. That is, the arrangement of the burnable poison inclusion fuel rods (4) corresponding to that of the fuel assembly (10) of Embodiment 3 is changed from that of the fuel assembly (10), and the enrichment of each of the fuel rods U1, U5, G, P1 and P2 is changed from that of the fuel assembly (10) of Embodiment 3. The constitution of the fuel assembly (1D) other than above is the same as the fuel assembly (10).

The enrichment of the concentrated uranium region of each of the fuel rods U1, G, and P2 is 4.0 wt %, and the enrichment of the concentrated uranium region of each of the fuel rods U5 and P1 is 6.5 wt %. The burnable poison inclusion fuel rods (4) (fuel rods G) are arranged at the outermost layer, second and fourth layers from the outside. The burnable poison inclusion fuel rods (4) are arranged at corners in the outermost layer. The burnable poison inclusion fuel rods (4) are not arranged at the third layer from the outside.

In the embodiment, the average concentration of the lower portion cross section is approximately 4.6 wt %, the average concentration of the middle portion cross section is approximately 4.7 wt %, and the average concentration of the upper portion cross section is approximately 4.4 wt %. The average enrichments of the outermost layer are 5.6 wt % in the lower portion, 5.6 wt % in the middle portion, and 4.0 wt % in the upper portion. Then, the ratios e/x become 1.21 in the lower portion, 1.20 in the middle portion, and 0.91 in the upper portion.

By substituting the average enrichment 4.6 wt % of the lower portion cross section in the fuel assembly (1D) into equation (3), the ratio e/x of the lower portion is determined to be 1.122. Accordingly, the ratio e/x (=1.21) of the lower portion is larger than the ratio e/x (=1.122) obtained by equation (3), and the lower portion satisfies equation (1). By substituting the average enrichment 4.7 wt % of the middle portion cross section into equation (3), the ratio e/x of the middle portion is determined to be 1.063. Accordingly, the ratio e/x (=1.20) of the middle portion is larger than the ratio e/x (=1.063) obtained by equation (3), and the middle portion also satisfies equation (1). By substituting the average enrichment 4.4 wt % of the upper portion cross section into equation (3), the ratio e/x of the upper portion obtained is determined to be 1.063. Accordingly, the ratio e/x (=0.91) of the lower portion is smaller than the ratio e/x (=1.063) obtained by equation (3), and the upper portion does not satisfy equation (1).

In the embodiment, since equation (1) is satisfied in the lower portion and the middle portion, gadolinium content contained in the fuel assembly (1D) at burnup 0 GWd/t can be reduced, reactivity of the fuel assembly (1D) in the first period can be restrained, and reactivity of the fuel assembly (1D) in the second period can be increased. In the embodiment, on-peak reactivity after gadolinium has perished (the on-peak reactivity is formed by satisfying equation (1)) can be increased by 0.1% Δk over the reactivity of the fuel assembly (1D) at burnup 0 GWd/t when loaded in the core. For that reason, the fuel assembly (1D) of the embodiment can increase discharge burnup by approximately 1.5% and can improve utilization efficiency of uranium by 1.5%.

Moreover, in the embodiment, since the burnable poison inclusion fuel rods (4) (fuel rods G) are arranged at the outermost layer of the fuel assembly, the peaking of the outermost layer can be restrained before gadolinium in the fuel assembly (1D) has perished, and a linear heat generating rate can be reduced before gadolinium has perished.

### Embodiment 6

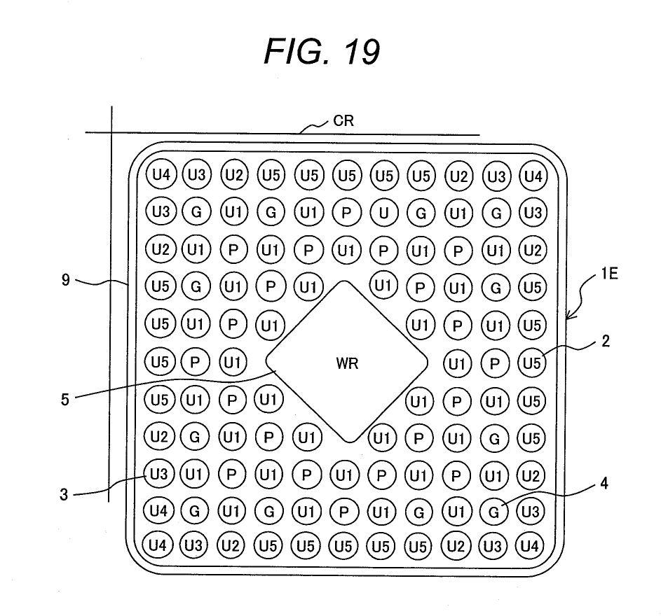

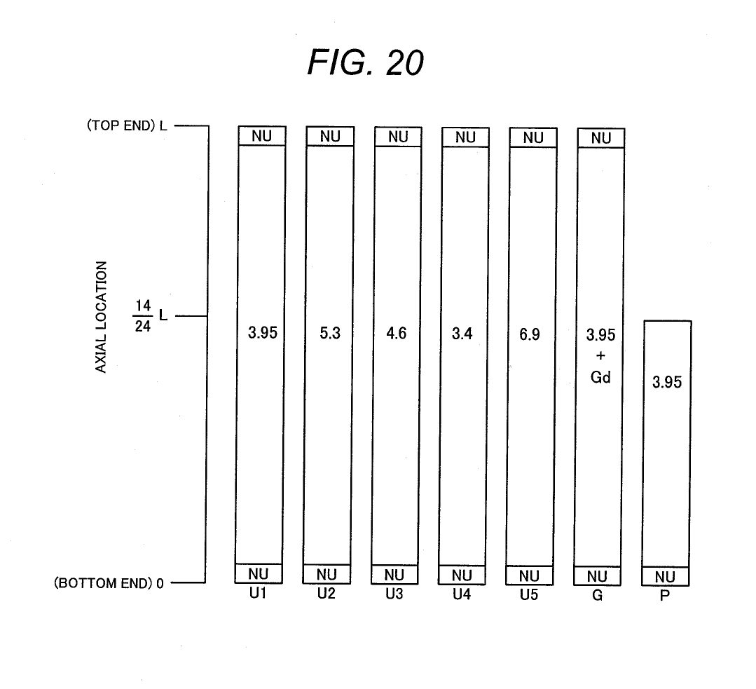

A fuel assembly of Embodiment 6 as another embodiment of the present invention to be applied to a BWR, will be described with reference to FIG. 19 and FIG. 20. A fuel assembly (1E) of the embodiment has a constitution where the fuel rod arrangement corresponding to that of the fuel assembly (1) of Embodiment 1 is changed to 11 rows by 11 columns, and a large water rod (5) having the cross section of quadrangle is applied to the fuel assembly. The large water rod (5) is arranged at the central part of cross section of the fuel assembly (1E). The burnable poison inclusion fuel rods (4) (fuel rods G) are arranged at the second layer from the outside and are not arranged in the region other than the second layer including the outermost layer. The constitution of the fuel assembly (1E) other than above is the same as the fuel assembly (1).

The enrichment of each concentrated uranium region of the fuel rods U1, U2, U3, U4, U5, G and P used in the fuel assembly (1E) is the same as that of each concentrated uranium region of the fuel rods U1, U2, U3, U4, U5, G and P used in the fuel assembly (1). In the concentrated uranium region of the fuel assembly (1E), the average enrichment of the cross section in the lower portion where the partial length fuel rods P exist is approximately 4.6 wt %, and the average enrichment of the cross section in the upper portion where the partial length fuel rods P do not exist is approximately 4.8 wt %. The average enrichments of the outermost layer are approximately 5.8 wt % both in the upper portion and lower portion. The ratios e/x in the fuel assembly (1E) are 1.21 in the upper portion of the fuel assembly (1E) and 1.25 in the lower portion of the fuel assembly (1E). The fuel assembly (1E) is a peripheral peak type fuel assembly.

By substituting the average enrichment 4.6 wt % of the lower portion cross section into equation (3), the ratio e/x of the lower portion in the fuel assembly (1E) is determined to be 1.12. Accordingly, the ratio e/x(=1.25) of the lower portion in the fuel assembly (1E) is larger than the ratio e/x(=1.12) obtained by equation (3), and the lower portion satisfies equation (1). By substituting the average enrichment 4.8 wt % of the lower portion cross section into equation (3), the ratio e/x of the upper portion in the fuel assembly (1E) is determined to be 1.11. Accordingly, the ratio e/x(=1.21) of the fuel assembly (1E) in the upper portion of the concentrated uranium region is larger than the ratio e/x(=1.11) obtained by equation (3), and the embodiment satisfies equation (1).

In the embodiment, since equation (1) is satisfied, each effect that arises in Embodiment 1 can be obtained. Moreover, in the embodiment, since the number of the fuel rods is increased, the linear heat generating rate declines compared to Embodiment 1, thereby the thermal margin is improved.

### Embodiment 7

A fuel assembly of Embodiment 7 as another embodiment of the present invention to be applied to a BWR, will be described. The fuel assembly of the embodiment has a constitution where the fuel effective length is changed in the fuel assembly (1) of Embodiment 1. The constitution of the fuel assembly of the embodiment other than above is the same as the fuel assembly (1). In the fuel assembly of the embodiment, the fuel effective length is 4.1 m by increasing the effective length of the fuel assembly (1) of Embodiment 1, 3.7 m by 10%. Specifically, the fuel effective length of each of the fuel rods U1, U2, U3, U4, U5, and G is 4.1 m. The fuel effective length of the partial length fuel rods P used in the embodiment is also longer than the effective length of the partial length fuel rods P used in Embodiment 1 by 10%. The fuel loading amount of the fuel assembly and the core volume of the embodiment increase by 10% compared with Embodiment 1.

In the embodiment, since equation (1) is satisfied, each effect that arises in Embodiment 1 can be obtained. Moreover, in the embodiment, since the boiling length is lengthened along with the lengthened fuel effective length, the critical power is increased by 5%, and the linear heat generating rate of the fuel assembly is decreased by 10%, the economical efficiency of nuclear fuel is increased by 10%.

What is claimed is:

1. A fuel assembly comprising:
plural first fuel rods containing fissile material and not containing burnable poison;
plural second fuel rods containing fissile material and burnable poison;
a lower tie plate that supports each bottom end of the first fuel rods and the second fuel rods; and
an upper tie plate that supports each top end of the first fuel rods and the second fuel rods,
wherein, when a first average enrichment as an average enrichment of a cross section of the fuel assembly is expressed by x (wt %) and a second average enrichment as an average enrichment of an outermost layer in a fuel rod arrangement is expressed by e (wt %), the ratio of the second average enrichment e (wt %) to the first average enrichment x (wt %) e/x satisfies equation (1).
$$\begin{matrix}[ Equation 1 ] & \\ \frac{e}{x} \geq - 18.3 {( \frac{x}{10} )}^{5} + 68.766 {( \frac{x}{10} )}^{4} - 101.77 {( \frac{x}{10} )}^{3} + 74.428 {( \frac{x}{10} )}^{2} - 27.372 ( \frac{x}{10} ) + 5.1682 & ( 1 )\end{matrix}$$

2. The fuel assembly according to claim
wherein the ratio e/x satisfies equation (2).
$$\begin{matrix}[ Equation 2 ] & \\ \frac{e}{x} \geq - 0.1031 x + 1.9096 & ( 2 )\end{matrix}$$

3. The fuel assembly according to claim 1,
wherein the fuel assembly has a first portion where the e/x satisfies equation (1) and a second portion where the e/x does not satisfy equation (1), and the second portion is located nearer to the upper tie plate than the first portion in a fuel effective length of the fuel assembly.

4. The fuel assembly according to claim 1,
wherein plural partial length fuel rods to be the first fuel rods are arranged at the outermost layer.

5. The fuel assembly according to claim 3,
wherein plural partial length fuel rods to be the first fuel rods are arranged at the outermost layer, and top ends of the partial length fuel rods exist in the first portion.

6. The fuel assembly according to claim 3,
wherein in the second portion, the second average enrichment e (wt %) is lower than the first average enrichment x (wt %).

7. The fuel assembly according to claim 1,
wherein the second fuel rods are arranged at the outermost layer.

8. The fuel assembly according to claim 7,
wherein the second fuel rods arranged at the outermost layer are arranged at corner parts of the outermost layer.

9. The fuel assembly according to claim 1,
wherein fuel rods including the first fuel rods and the second fuel rods are arranged in 11 rows by 11 columns.

10. The fuel assembly according to claim 1,
wherein fuel effective length of the fuel rods is in the range of 3.8 m to 5 m.
